(19) United States
(12) Patent Application Publication
(10) Pub. No.: US 2023/0332299 A1
(43) Pub. Date: Oct. 19, 2023

(54) WATER ELECTROLYSIS DEVICE FOR HYDROGEN PRODUCTION

(71) Applicants: Centre national de la recherche scientifique, PARIS (FR); INSTITUT PHOTOVOLTAÏQUE D'ILE DE FRANCE (IPVF), PALAISEAU (FR); L'AIR LIQUIDE, SOCIETE ANONYME POUR L'ETUDE ET L'EXPLOITATION DES PROCEDES GEORGES CLAUDE, PARIS (FR); ELECTRICITE DE FRANCE, PARIS (FR); TotalEnergies OneTech, COURBEVOIE (FR)

(72) Inventor: David AYME-PERROT, HUNINGUE (FR)

(73) Assignees: Centre national de la recherche scientifique, PARIS (FR); INSTITUT PHOTOVOLTAÏQUE D'ILE DE FRANCE (IPVF), PALAISEAU (FR); L'AIR LIQUIDE, SOCIETE ANONYME POUR L'ETUDE ET L'EXPLOITATION DES PROCEDES GEORGES CLAUDE, PARIS (FR); ELECTRICITE DE FRANCE, PARIS (FR); TotalEnergies OneTech, COURBEVOIE (FR)

(21) Appl. No.: 18/013,116

(22) PCT Filed: Jun. 29, 2021
(86) PCT No.: PCT/EP2021/067797

§ 371 Date: Dec. 27, 2022

(30) Foreign Application Priority Data
Jun. 30, 2020 (FR) FR2006861

(51) Int. Cl. C25B 1/04; C25B 9/40; C25B 11/037; C25B 11/043; C25B 9/65

(52) U.S. Cl. CPC C25B 1/04; C25B 9/43; C25B 11/037; C25B 11/043; C25B 9/65

(57) ABSTRACT

The invention relates to an electrolysis device and method for producing molecular hydrogen, the device comprising a negative electrode compartment for reducing H2O into H2 and a positive electrode compartment comprising circulating supercapacitive particles in contact with a conductive substrate. Such a device or method advantageously comprises a power supply provided by one or more photovoltaic cells.

### CROSS REFERENCE TO RELATED APPLICATIONS

The present application is a U.S. National Phase Application under 35 U.S.C. § 371 of International Patent Application No. PCT/EP2021/067797 filed Jun. 29, 2021, which claims priority of French Patent Application No. 20 06861 filed Jun. 30, 2020. The entire contents of which are hereby incorporated by reference.

### FIELD OF THE INVENTION

The present invention relates to a water electrolysis device and method for the production of hydrogen.

The present invention more particularly concerns a device for generating hydrogen using particles having supercapacitive property circulating in the positive compartment of an electrolytic cell, and a method using said device. Advantageously, said device results from the coupling of a supercapacitor positive electrode (anode) in suspension with a negative electrode (cathode) for reducing water to hydrogen (HER).

### BACKGROUND

At the current time, the production of «green» hydrogen via electrolysis is more costly than the production of «grey» hydrogen via methane reforming. The electrolysers used are costly through the use of noble metals, ion-conducting membranes, the architecture of multi-element cells, etc.

For water electrolysis, a sufficient water splitting electrical voltage is applied to generate dihydrogen (called hydrogen through misuse of language) in a cathode compartment (the term HER is used: Hydrogen Evolution reaction), and dioxygen (called oxygen through misuse of language) in an anode compartment (the term OER is used: Oxygen Evolution Reaction). Both compartments are conventionally separated by an ion-conducting membrane ensuring the conductivity of the electrochemical cell assembly and preventing mixing of the gases.

This conventional configuration with two compartments ultimately has some operating limits. Foremost is the level of hydrogen production which is limited since it is intrinsically related to the level of the oxygen evolution reaction (OER), which kinetically is highly limiting. In addition, diffusion of the gases from one compartment to the other cannot be fully prevented, despite the use of an ion membrane assumed to be impermeable to said gases. This parasitic effect affects the global yield of electrolysis. In addition, the presence of said H₂/O₂ mixtures, even in small amounts, can lead to parasitic reactions deteriorating the catalysts and other membranes, and hence promoting ageing of the electrolyser.

One approach to avoid this kind of scenario is to decouple the water electrolysis reaction, namely to produce time-staggered and/or space-staggered release of hydrogen and oxygen. In other words, the hydrogen and oxygen are not produced simultaneously within the system. This definitely prevents potential mixing of the gases, this mixing remaining extremely reactive and hazardous. As a result, this approach allows the envisaging of system architectures that are safer and even less costly.

Different decoupled systems for water electrolysis are reported in the literature.

The use of Redox mediators was initiated in particular by Cronin et al. (Nat. Chem. 2013, 5, 403-409) which allows decoupling of water electrolysis into two steps under polarization. At a first step, the redox mediator (e.g. phosphomolybdic acid (H₃O⁺)[H₂PMo₁₂O₄₀]) is reduced at the cathode under polarization with release of oxygen at the anode. At a second step, the reduced mediator is re-oxidized at the anode and hydrogen is produced at the cathode.

Other approaches place a specific faradaic electrode in contact with a hydrogen-generating electrode.

In WO201784589, Yonggang et al. (Fudan University) describe a 3-electrode electrolytic tank in an alkaline medium, namely a HER catalytic electrode, an OER catalytic electrode and an intermediate Ni(OH)₂ electrode which allows the generating of hydrogen via two-step water electrolysis. At a first step, a sufficient voltage is applied between the HER electrode and Ni(OH)₂ electrode. Although the Ni(OH)₂ electrode has a higher redox potential than that of water oxidation, the kinetics of this latter reaction are so slow that oxidation of Ni(OH)₂ has preferable occurrence. The water molecules are electrochemically reduced to H₂ at the HER cathode whilst the nickel hydroxide cathode Ni(OH)₂) is oxidized to nickel oxyhydroxide (NiOOH). At a second step, the system coupling the NiOOH electrode with the OER electrode is slightly polarized. The NiOOH electrode is reduced and returns to its initial Ni(OH)₂ state, and the hydroxide ions oxidize to oxygen. With this system it is therefore possible to produce hydrogen and oxygen staggered fashion without requiring the use of a particular membrane, on the other hand the end voltage used (sum of the polarization voltages of the 2 steps) remains similar to that of conventional electrolysis.

In US 2020/040467, Rothschild et al. place a positive Ni(OH)₂ electrode in contact with a negative water-reducing electrode. Therefore, at the time of charging the system, the protons are reduced to hydrogen at the cathode, and the nickel hydroxide anode is oxidized to nickel oxyhydroxide (NiOOH). Once this electrode is fully charged, the system must be halted and regenerated. The authors have developed thermal regeneration of the NiOOH electrode. By heating the cell to 95° C., the NiOOH electrode is reduced by water to Ni(OH)₂. The system can then again be charged to produce hydrogen.

The limit of this latter approach lies in the use of a Faradaic electrode having necessarily limited capacitance. This finite capacitance therefore requires a charge/regeneration process over time. In the event of coupling with photovoltaic powering, the regeneration time does not allow direct use of all the electrons produced.

Within this context, one idea for increasing operating times is to use faradaic systems of redox flow type which place in contact suitable redox species. The other advantage is production of the gases in time or space-separated manner compared with redox flow batteries. Amstutz et al. claim the use of a flow battery of V³⁺/V²⁺ type at the negative electrode and of Ce³⁺/Ce⁴⁺ type at the positive electrode. These two pairs have potentials above the thermodynamic window of water (1.23V). However, having regard to the sufficiently slow kinetics of H₂ and O₂ release on the substrate electrodes used, the reactions of reducing V³⁺ to V²⁺ at the cathode and of oxidizing Ce³⁺ to Ce⁴⁺ at the anode are given preference. The system being a flow system, V²⁺ and Ce⁴⁺ are therefore carried towards different tanks outside the electrochemical cell. The two redox species can therefore be conveyed towards catalytic columns containing catalysts adapted for the HER and OER reactions respectively, V²⁺ is then oxidized by the protons to generate hydrogen and Ce⁴⁺ is reduced by the water to generate oxygen. Release of the gases is spatially separated and potentially separated in time by means of the flow of materials involved.

Additionally, supercapacitors (or electrochemical capacitors) are highly cyclable devices for storing electrical energy. Under electrical polarization, the two inert electrodes of the system immersed in an electrolyte are charged: one positively, the other negatively. The positive electrode attracts the anions of the electrolyte; while the negative electrode attracts the cations. An electrochemical double layer is therefore formed at the interfaces of the two electrodes, forming an energy storage mode of electrostatic origin.

Finally, patent application EP 0082514 concerns particles suitable for use as electrode material comprising a substrate at least partially coated with a mixture of hydrophobic material and an electrochemically active and electrically conductive catalyst. However, EP 0082514 sets out to prevent the production of hydrogen.

Patent application CN 107 393 725 concerns a composite porous conductive carbon material loaded with NiCo₂O, the preparation method thereof and application thereof in a supercapacitor, but does not describe the solution proposed in the present invention.

### SUMMARY

It is the objective of the invention to solve the technical problem of providing a water electrolysis device and method for the production of hydrogen (H₂).

In particular, the present invention endeavors to solve the technical problem of providing a water electrolysis device and method for the production of hydrogen which prevents the production of oxygen (O₂) at the anode, and more particularly prevents the simultaneous production of the two gases H₂ and O₂, and hence the potential mixing thereof in the event of an incident.

It is the objective of the invention to promote the rate of hydrogen production by preventing the slow and limiting reaction of oxygen generation, and hence to be able to operate at high current density.

A further objective of the invention is to solve the technical problem of providing a water electrolysis device and method for the production of hydrogen, which avoids the use of a costly conducting separator membrane such as a proton exchange membrane or polymer electrolyte membrane (PEM).

A further objective of the invention is to solve the technical problem of providing a water electrolysis device and method for the production of hydrogen, by providing a simpler electrode architecture than that of existing electrolysers, and in particular by reducing manufacturing and operating costs.

A further objective of the invention is to solve the technical problem of providing a water electrolysis device and method for the production of hydrogen, having a good lifetime.

A further objective of the present invention is to solve the technical problem of providing a water electrolysis device and method for the production of hydrogen, which limits impact on the environment and preferably uses a renewable energy source.

The present invention sets out to solve the above technical problems in reliable, industry-applicable manner.

### BRIEF DESCRIPTION OF THE DRAWINGS

FIG. 1 schematically illustrates an electrolysis device 1 which comprises a positive electrode compartment 10 comprising a positive electrode 15 and a negative electrode compartment 20 comprising a negative electrode 25. In FIG. 1, the device powering the electrolysis device 1 is not illustrated.

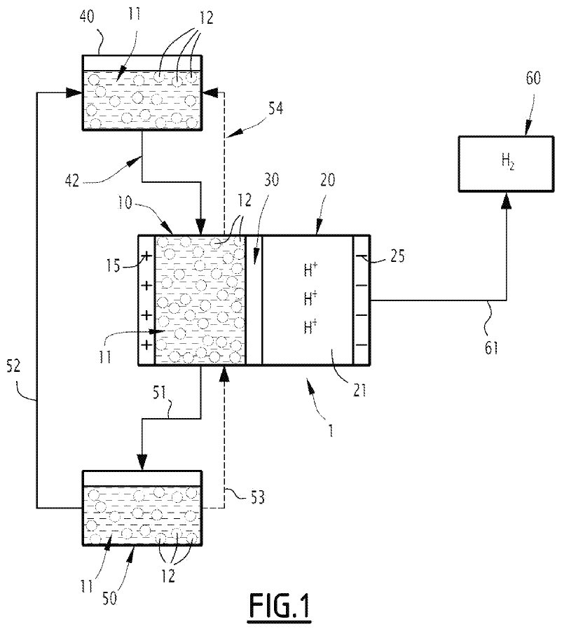

FIG. 2 schematically illustrates the behavior of the negative electrode in linear voltammetry and the response of the positive electrode in cyclic voltammetry (standard calomel electrode).

### DETAILED DESCRIPTION

The invention relates to the generation of hydrogen from an aqueous electrolyte via a specific electrochemical device and method.

The electrolysis device (or electrolyser) of the invention allows the generation of dihydrogen from water (H₂O).

In particular, the invention concerns a device for the electrolysis of an aqueous electrolyte for the production of dihydrogen.

In one variant, the device of the invention produces dihydrogen from solar energy, and comprises electrical powering by one or more photovoltaic cells. The electrolysis device of the invention is advantageously directly coupled to one or more photovoltaic cells (PV).

The invention can therefore concern a system of photoelectrochemical cell type (PEC).

The invention concerns an electrolysis device for the production of dihydrogen, said device comprising a negative electrode compartment for reducing H₂O to H₂ and a positive electrode compartment comprising circulating supercapacitive particles in contact with a conductive substrate.

In particular, the positive electrode compartment forms a supercapacitive electrode in suspension.

The invention also concerns an electrolysis method for the production of dihydrogen, characterized in that it comprises the use of a device of the invention.

The invention also concerns an electrolysis method for the production of dihydrogen, characterized in that it comprises circulation of supercapacitive particles in a positive electrode compartment and powering which limits the operating voltage to below the potential for water splitting to prevent the release of dioxygen, optionally said electrolysis device being powered with electricity by one or more photovoltaic cells.

Therefore, the invention relates to a water electrolysis device and method.

Said electrolysis device or method for the production of dihydrogen according to the invention can be termed a device or method for producing dihydrogen via electrolysis.

The invention further concerns the use of coupling a negative water-reducing electrode for the production of dihydrogen with a supercapacitive flow system as positive electrode.

Advantageously, in one variant, the electrolysis device comprises electrical powering via one or more photovoltaic cells.

Advantageously, the system solely generates hydrogen as gas.

In one variant, the device conforming to the invention consists of a prior art electrochemical cell for water electrolysis in which the anode of the electrolyser (site of the oxygen evolution reaction—OER) is replaced by a supercapacitive electrode in suspension having flow operation.

The terms «supercapacitive electrodes» or «supercapacitive particles» respectively designate electrodes or particles forming electrodes, having an electrochemical double layer on the surface or having redox activity similar to pseudo-capacitive behavior under polarization. Charge storage is wholly or essentially of electrostatic type. The capacitance (expressed in Farads) of an electrode is equal to: C=ε·S/e, with ε: the relative permittivity of the electrolytic solution, S: the surface area of the electrode (site of the electrochemical double layer), e: the thickness of the electrochemical double layer.

Since capacitance is directly proportional to the surface area of the electrodes that are the site of the electrochemical double layer, the supercapacitive electrodes used are generally based on porous carbon developing a high specific surface area (typically between 500 and 3000 m²/g)

Other materials of metal oxide type (e.g. RuO₂, MnO₂) having several degrees of oxidation, or conductive polymers, in an aqueous medium, have redox activity comparable to supercapacitive behavior, in which case the terms pseudocapacitive materials/systems is used.

In one variant, the surfaces of the supercapacitive carbon particles are functionalized with heteroatoms (functions with N, O, etc.) or the addition is made of a redox mediator to generate additional redox activity comparable to pseudocapacitance.

All these carbon or metal oxide materials are the site of surface storage of charges promoting system power but limiting the amount of energy that can be stored.

To increase stored energy in a supercapacitive system, there exist flow supercapacitors (or electrochemical capacitors) based on carbon particles in suspension in an electrolyte which become charged in contact with polarized substrate electrodes (K. B. Hatzell, Y. Gogotsi, et al., Electrochimica Acta 111 (2013) 888-897). Charge transfer therefore occurs from the polarized substrate electrode towards the particles. Once charged/polarized, the particles attract the counter ions of the electrolyte, the surface thereof becoming the site of an electrochemical double layer (specifically located at the particle/electrolyte interface).

Therefore, in one variant, the supercapacitive particles are carbon particles that are the site of an electrochemical double layer.

In another variant, the supercapacitive particles are particles having redox activity comparable to pseudocapacitive behavior under polarization.

Advantageously, the supercapacitive particles are carbon particles.

Advantageously, the conductive carbon particles have a BET specific surface area greater than 500 m²/g.

Advantageously, the supercapacitive particles have a mean diameter of 1 to 500 μm, preferably of 10 to 500 μm.

In one embodiment, the supercapacitive particles have a specific capacitance of 50 to 500 F/g.

In one embodiment, the supercapacitive particles are conductive carbon particles having a specific capacitance of 50 to 500 F/g in an aqueous medium.

For example, conductive carbon particles frequently used in supercapacitors can be employed, such as activated carbon (AC), carbon fiber cloth (CFC), carbide-derived carbon (CDC), carbon aerogel, graphite, graphene or carbon nanotubes (CNTs).

They may be of activated carbon black type e.g. NORIT A ULTRA® or DARCO® by CABOT.

The supercapacitive particles are positively charged (polarization) in contact with the electrode (conductive substrate) in the compartment of the positive electrode.

Typically, the electrode is a conductive substrate that is resistant in the aqueous medium under consideration: noble metal, stainless-steel, carbon, nickel (foam), or nickel alloy.

Typically, the supercapacitive particles are suspended in a charge-conducting liquid medium, the term electrolytic medium being used.

In one embodiment, the electrolytic medium comprising the conductive carbon particles is a solution, preferably an aqueous solution and typically a concentrated solution of conductive carbon particles called a slurry.

Preferably, the electrolytic medium is an aqueous medium.

Typically, the electrolysis device of the invention comprises an aqueous electrolytic solution in the positive electrode compartment. Advantageously, the electrolytic medium comprises an electrolyte adapted for the positive electrode compartment.

Therefore, preferably, said device of the invention comprises a negative electrode compartment for reducing H₂O to H₂ and a positive electrode compartment comprising an aqueous solution of circulating supercapacitive particles in contact with a conductive substrate, said device in the negative electrode compartment comprising an aqueous electrolytic medium for reducing water to hydrogen.

Typically, the electrolyte in an acid medium allows production of the reaction at the negative electrode: 2H⁺+2 e⁻->H₂ (cathodic reaction). Simultaneously, the counter ions of the electrolyte (e.g. SO₄²⁻ or Cl⁻, etc.) accumulate on the surface of the positively charged supercapacitive particles in the anode compartment.

Typically, the electrolyte in a basic medium allows production of the reaction at the negative electrode: 2H₂O+2 e⁻->H₂+2 OH⁻ (cathodic reaction). Simultaneously, the hydroxide anions of the electrolyte accumulate on the surface of the positively charged supercapacitive particles in the anode compartment.

In one embodiment, the electrolytic medium is acid and comprises H₂SO₄ (typically at a concentration of 1 M to 2 M).

In one embodiment, the electrolytic medium is alkaline and comprises NaOH or KOH (concentration 3 to 10 M, typically 5 M).

Preferably, the electrolyte in the positive electrode compartment is the same as the one in the negative electrode compartment.

In one embodiment, the carbon/liquid weight ratio of the electrolytic medium containing the conductive carbon particles is from 0.05 to 0.95, and preferably from 0.05 to 0.75.

As for any electrode, there is mixing of the supercapacitive particles with finer particles of carbon black which promotes electrical conductivity.

Preferably, the particles are stored outside the cell in one or more reservoirs.

More preferably, the device comprises a reservoir of supercapacitive particles in fluid contact with the positive electrode compartment.

In one variant, a reservoir is arranged upstream of the inlet of supercapacitive particles into the positive electrode compartment.

Typically, said reservoir stores supercapacitive particles in essentially and preferably fully discharged state. By «essentially discharged», it is meant that they are sufficiently discharged to allow charging thereof in satisfactory manner for operation of the electrolysis device when passing into the positive electrode compartment.

In one variant, a reservoir is arranged downstream of the outlet of the supercapacitive particles from the positive electrode compartment.

Typically, said reservoir stores supercapacitive particles in essentially and preferably fully charged state. By «essentially charged», it is meant that they are sufficiently charged after passing into the positive electrode compartment for satisfactory operation of the electrolysis device.

In one variant, the device allows continuous or semi-continuous operation.

In one embodiment, the electrolysis device comprises a first reservoir upstream of the positive electrode compartment for storing supercapacitive particles in discharged state, which are injected into the electrode compartment to be charged therein when circulating in the electrode compartment, and they are then sent to a second storage reservoir downstream of the electrode compartment to be stored in charged state. Advantageously, the supercapacitive particles discharge alone via self-discharge. Typically, said (self)-discharge can be obtained within a few hours in an aqueous medium, for example overnight (5 to 10 h). The discharged conductive particles are again operational for new entry into the positive electrode compartment, for charging thereof.

In one embodiment, the supercapacitive particles are discharged by a discharging system.

In a first variant, the supercapacitive particles stored in the second reservoir can be recycled back to the first storage reservoir, without passing into the positive electrode compartment. In a second variant, the discharged supercapacitive particles in the second reservoir can be injected into the positive electrode compartment for circulation and charging thereof, after which the charged particles are sent into the first storage reservoir. In similar manner for the first cycle, the charged particles are stored for sufficient time in the first reservoir for discharging thereof. Sequencing of the cycles can be as follows:
In the first variant: first reservoir->electrode->second reservoir->first reservoir.
In the second variant: first reservoir->electrode->second reservoir->electrode->first reservoir.

Advantageously, the flow of supercapacitive particles is determined as a function of the instantaneous charge to be stored electrostatically at the positive electrode to counterbalance the desired/used charge to reduce the water/proton to dihydrogen.

In one variant, the volume of the medium containing the carbon particles and/or the concentration of conductive carbon particles in the liquid medium, and hence the size of the storage reservoir(s) containing the same, is determined as a function of the capacity and desired charge of the positive electrode.

Therefore, for an operating capacity, the size of the reservoir can be determined accordingly.

Typically, the electrolysis device comprises electrical powering to set up a potential difference between the positive electrode and negative electrode. Typically, when being electrically powered, the device generates hydrogen for as long as the charge capacity of the anode compartment (positive electrode compartment) is not fully charged.

Any electrolyser electrode can be used allowing the generation of dihydrogen, as electrode of the negative electrode compartment.

For example, use can be made:
In an acid medium;
of an electrode in Platinum, Palladium, Molybdenum sulfide, etc.
In a basic medium:
of nickel, nickel alloys.

In one variant, advantageously the amount of catalyst can also be reduced (for example with a Pt electrode) or less costly catalysts can be used if efficiency under a strong current is not necessary.

Typically, the positive electrode compartment and negative electrode compartment are separated by a membrane. This can be a fully conventional separator membrane for an electrolyser. For example, use can be made of a more conventional separator membrane of cellulose type, or porous surface-functionalized PP/PE films.

Advantageously, to promote the pressure of produced hydrogen, the separator membrane can be a proton exchange membrane (PEM in acid medium, of Nafion® type), and to a lesser extent an ion membrane (in alkaline medium).

Advantageously, the electrolysis device of the invention is connected to a powering device, allowing a potential difference to be set up between the anode and cathode. According to prior art, the electrolysers are sized to operate at high current densities in the region of 0.5 to 4 A/cm².

The voltage required to obtain said current densities is high, higher than or equal to 1.9 V (compared with 1.23 V for the thermodynamic water splitting voltage under standard conditions). Typically, the operating voltage corresponds to the sum of the thermodynamic water splitting voltage, kinetic overvoltages at the two electrodes and ohmic drops. Here, it is the slow kinetics of O₂ release at the anode which require an overvoltage in the region of 0.4 V and higher to operate under the indicated current conditions.

Yet, the invention operates at a voltage between the two electrodes (anode and cathode) lower than the operating voltage of a conventional electrolyser, since OER does not take place. Typically, therefore, the operating voltage corresponds to a voltage sum that is necessarily lower than the sum of the thermodynamic water splitting voltage, kinetic overvoltage of HER and ohmic drops. Advantageously, the invention allows limiting of the working voltage of the electrolyser.

Typically, the operating voltage required for the electrolyser is chosen to generate hydrogen at the cathode (HER), but preventing the generation of oxygen (OER) at the anode.

Therefore, advantageously, a powering device is used which allows the application of an operating voltage such as described above.

In one embodiment, the current density is higher than 10 mA/cm², and for example is higher than 100 mA/cm².

Advantageously, a device of the invention therefore comprises a negative electrode (HER cathode) associated with a positive electrode (supercapacitive flow electrode).

Advantageously, the invention prevents the production and in particular simultaneous production of the two gases H₂ and O₂, and hence potential mixing thereof in the event of an incident. This is because O₂ is not produced in the positive electrode compartment.

Advantageously, the invention avoids the providing of a complex separator device (spatial or temporal) of the electrodes.

In one embodiment, advantageously, the invention allows the use to be avoided of a separator membrane that is generally costly such as Nafion® membranes for example.

Advantageously, the invention allows the providing of a safer electrolysis device (H₂ and O₂ are highly reactive when placed together).

Advantageously, the invention allows the providing of an electrolysis device permitting the production of hydrogen from water, preferably in more efficient and especially less costly manner.

Advantageously, the invention allows the providing of a water electrolysis device and method having a good lifetime, in particular with potential recycling over several thousand cycles of the conductive carbon particles.

Since solely reduction of water takes place (and not oxidation thereof), the medium becomes increasingly more concentrated with OH⁻ ions with each cycle (as per the equations 1 and 1′), and it is therefore preferred periodically to readjust pH/quantity of electrolyte.

The device of the invention is explained within the framework of relatively simple operation. However, the device of the invention may comprise several compartments of positive electrode and/or negative electrode and several storage reservoirs. Therefore, whenever the expression «one» is used (for example one electrode) this is meant to designate «at least one» and covers the variants «one or more» (for example, one or more electrodes).

Advantageously, the invention allows the providing of an electrolysis device allowing coupling with one or more PV cells.

Advantageously, the invention allows the operating voltage to be reduced, and thereby advantageously allows the use of a reduced number of PV cells required for electrically powering the electrolysis device of the invention.

Advantageously, the invention allows the providing of so-called «green» dihydrogen since it is produced from solar energy for electrical powering of the electrolysis device, as opposed in particular to methane reforming.

Other objectives, characteristics and advantages of the invention will become apparent to persons skilled in the art on reading the explanatory description which refers to examples that are given solely for illustration purposes and cannot under any circumstance be interpreted as limiting the scope of the invention.

The examples form an integral of the present invention and any characteristic which appears to be novel compared with any prior art and apparent from the description taken as a whole, including the examples, is an integral part of the invention functionally and generally.

Therefore, each example has general scope.

Also, in the examples, all percentages are given by weight unless otherwise stated, the temperature is expressed in degrees Celsius unless otherwise stated, and pressure is atmospheric pressure unless otherwise stated.

The positive electrode compartment comprises an electrolytic medium 11 in which there are suspended particles of conductive carbon 12 circulating in the positive electrode compartment 10. The conductive carbon particles 12 become positively charged in the positive electrode compartment 10. The negative electrode compartment 20 comprises an electrolytic medium 21 comprising protons and generating gaseous hydrogen. The gaseous dihydrogen can be evacuated via a gas circulation line 61 and stored in a tank 60.

The electrolytic medium circulating in the positive electrode compartment 10 can be injected from a first storage reservoir 40 via a fluid circulation line 42. The electrolytic medium 11 circulating in the positive electrode compartment 10 can be directed from the positive electrode compartment 10 towards a second storage reservoir 50 via a fluid circulation line 51. The electrolytic medium 11 comprising the conductive carbon particles 12 can be recycled after discharging back to the first storage reservoir 40 via a fluid circulation line 52.

In one alternative, the recycling of the carbon particles 12 can be obtained by injection from the second reservoir 50 into the positive electrode compartment 10 via a fluid circulation line 53. The conductive carbon particles 12 become positively charged in the positive electrode compartment. The electrolytic medium 11 comprising the carbon particles 12 is then directed via a fluid circulation line 54 towards the first reservoir 40.

The charged conductive carbon particles 12 discharge in the storage reservoir 40 and/or 50 depending on the embodiment.

### EXAMPLES

Particle size is conventionally determined by particle size analysis of the type: dynamic light scattering (particles in suspension in a liquid, typically water), or laser diffraction.

The specific surface area (m²/g) of particles is conventionally determined by nitrogen adsorption and BET analysis (Brunauer, Emmett et Teller).

The capacitance of carbon electrodes is determined by potentiometry or cyclic voltammetry. Typically, the working electrode to be characterized is immersed in the electrolyte and is connected to a counter electrode (generally insert) via a potentiostat/galvanostat. A reference electrode is used e.g. a calomel electrode in an aqueous medium, to measure the change in potential as a function of the charge transported between the working electrode and the counter electrode. In potentiometry, a constant current is applied to the electrode, and the potential thereof grows linearly as a function of the applied charge, from its potential of zero charge to the maximum limit potential applied. Capacitance corresponds to the inverse of the slope obtained. In linear or cyclic voltammetry, potential sweeping is performed (at a predefined scan rate in mV/s) from the potential of zero charge to the limit potential, the current response is a plateau. The ratio between the current I of this plateau and scan rate gives the capacitance of the electrode.

### Example 1—Static Hybrid System

An electrochemical cell is used composed of:
a negative electrode in platinum
and a positive supercapacitive electrode in porous monolithic carbon (specific surface area 500 m²/g), both having a surface area of 1 cm².

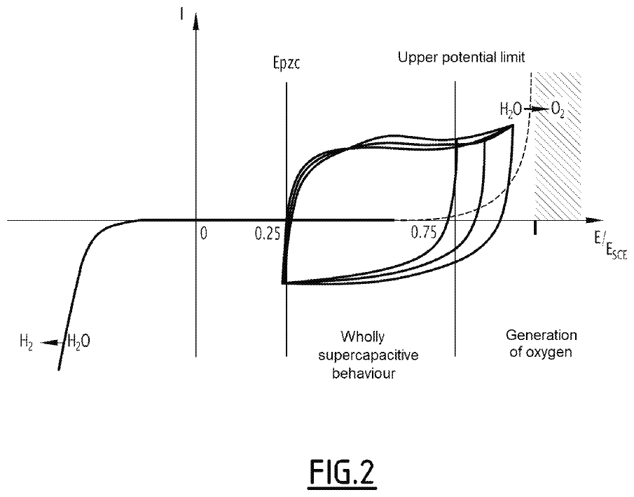

An example of the behavior of the negative electrode in linear voltammetry, and the response of the positive electrode in cyclic voltammetry (calomel reference electrode) is illustrated in FIG. 2.
Dimensions of the carbon electrode:
Surface area: 1 cm²
Thickness: 300 μm
Volume: 0.03 cm³

The electrolyte is an acid electrolyte: 1 M H₂SO₄.

When powered, the following is observed:
A reaction of «HER» type at the negative electrode: Cathodic reduction: 2H⁺+2 e⁻ →H₂

The carbon electrode is positively charged under polarization. It attracts the ions of opposite charge (here SO₄²⁻ anions) contained in the electrolyte. Storage is electrostatic in the form of an electrochemical double layer.

The carbon electrode has positive specific capacitance Cₘ=100 F/g, and density of 0.9.

The volumetric capacitance is: Cᵥ=100×0.9=90 F/cm³

Let the point of zero charge of the electrode be: E(PZC)=0.5 V vs SHE (PZC: “point of zero charge”) (SHE: Standard Hydrogen Electrode)

The positive electrode assuredly exhibits wholly capacitive behavior over the potential range 0.5 V to 1 V (ΔU=0.5V).

The capacitance of the electrode is: C=Cᵥ×V=90*0.03=2.7 F

The charge Q able to be stored in the carbon electrode is: Q=C×ΔU=2.7×0.5=1.35 C (Coulomb)

Reminder: Q=I×t=C×U

Charge time (=cell operating time): t=(C×U)/I

For powering with a constant current, the corresponding charge time is calculated:

TABLE 1

| Current feed (mA/cm2) | Charge time (s) |
|---|---|
| 10 | 135 s |
| 100 | 13.5 |
| 500 | 2.7 |

The charge stored in the capacitive electrode corresponds to the effective charge to generate H₂. Q=1.35 C

Reminder: 1 F=96500 C/mol; molar gas volume: 22.4 L/mol

Therefore, for n(mol e−)=1.40×10⁻⁵ mol, we obtain n(mol H₂)=6.99×10⁻⁶ mol, therefore the maximum volume of generated hydrogen is: Vol(H₂)=0.157 mL(/cm² of electrode)

Evidently, in a static system, the capacitance of a 140 monolithic» carbon particle supercapacitive electrode remains very limited compared with that of a faradaic electrode (battery), hence the use of a flow of carbon particles (Example 2).

In this manner, the finite charge of the carbon particles is offset by a flow adapted for renewal thereof.

### Example 2—Dynamic Hybrid System

An electrochemical cell is used composed of:
a negative electrode in platinum in the negative compartment
a positive electrode (stainless-steel mesh substrate) with flow of carbon particles (having the same specific surface area as the carbon in Example 1)

When powered:
A reaction of «HER» type takes place at the negative electrode: Cathodic reduction: 2H⁺+2 e⁻→H₂

The conductive carbon particles circulating in a flow in the positive electrode compartment become charged in contact with the stainless-steel electrode (substrate).

The same capacitive characteristics are maintained for the carbon particles as for the monolithic carbon in Example 1.

Content of carbon particles in the aqueous electrolyte (slurry): 0.25 (solid/liquid weight ratio)

Let the density of the working current be set at 100 mA/cm².

Surface area of the electrode S=1 cm²

Reminder: The charge time of a carbon electrode of 0.03 cm³ is 13.5 s at 100 mA/cm² (cf. Example 1)

Therefore, the quantity of slurry used for an operating time of 1 h at 100 mA/cm² is:

TABLE 2

| | | Equivalent | Volume | |
|---|---|---|---|---|
| | | volume of | of | Slurry |
| Operating | Charge under | carbon | transported | flow rate |
| time (h) | consideration | particles | slurry | (cm³/h/cm² |
| (at 100 mA/cm2) | (C) | (cm³) | (cm³) | electrode) |
| 1 | 360 | 8 | 32 | 32 |

Therefore, with an operating time of 10 h (potential sunlight over 1 day), we obtain:
=>320 cm³ of electrolytic medium containing the conductive carbon particles (slurry) is used to store the charge under consideration for an electrode surface area of S=1 cm²
(i.e. 3 200 000 cm³=3.2 m³ of slurry for a surface area S=1 m²)

Maximum quantity of hydrogen generated in 10 h:

The transported charge is 3600 C, hence the H₂ volume is 418 mL/cm² of electrode (catalyst), i.e. 418 cm³ of H₂ produced for 320 cm³ of slurry used.

If the density of the working current is set at 500 mA/cm².

Reminder: the charge time of a carbon electrode (static) of 0.03 cm³ is 2.7 s at 500 mA/cm² (cf. Example 1).

Therefore, the quantity of slurry used for an operating time of 1 h at 500 mA/cm² is:

TABLE 3

| | | Equivalent | Volume of | Slurry flow rate |
|---|---|---|---|---|
| Operating time | Charge | volume of pure | transported | (cm³/h/cm2 |
| (h) | (C) | carbon (cm³) | slurry (cm³) | electrode) |
| 1 | 1800 | 40 | 160 | 160 |

Hence for an operating time of 10 h, we obtain:
=>1600 cm³ of slurry used for an electrode surface area S=1 cm² (i.e. 16 000 000 cm³=16 m³ of slurry used for S=1 m²)

Maximum quantity of hydrogen generated in 10 h:
The transported charge is 18000 C, therefore the volume of H₂ is 2.09 L/cm² of electrode (catalyst), i.e. 2 L of H₂ produced using 1.6 L of slurry.

1. An electrolysis device for the production of dihydrogen, said device comprising a negative electrode compartment for reducing H₂O to H₂, and a positive electrode compartment comprising circulating supercapacitive particles in contact with a conductive substrate.

2. The electrolysis device according to claim 1, wherein the positive electrode compartment forms a supercapacitive electrode in suspension.

3. The electrolysis device according to claim 1, wherein the supercapacitive particles are carbon particles.

4. The electrolysis device according to claim 3, wherein the conductive carbon particles have a BET specific surface area greater than 500 m²/g.

5. The electrolysis device according to claim 1, wherein the supercapacitive particles have a mean diameter of 1 to 500 μm.

6. The electrolysis device according to claim 1, wherein the supercapacitive particles have a specific capacitance of 50 to 500 F/g.

7. The electrolysis device according to claim 1, wherein it comprises a reservoir of supercapacitive particles in fluid contact with the positive electrode compartment.

8. The electrolysis device according to claim 1, wherein it comprises an aqueous electrolytic solution in the positive electrode compartment.

9. The electrolysis device according to claim 1, wherein said positive electrode compartment and the negative electrode compartment are separated by a membrane.

10. The electrolysis device according to claim 1, further comprises electrical powering to set up a potential difference between the positive electrode and negative electrode.

11. The electrolysis device according to claim 1 wherein it produces dihydrogen from solar energy, said electrolysis device comprising electrical powering by one or more photovoltaic cells.

12. An electrolysis method for producing dihydrogen, further comprises the use of a device according to claim 1.

13. The electrolysis method for producing dihydrogen according to claim 12, further comprises the circulation of supercapacitive particles in a positive electrode compartment, and powering which limits the operating voltage to below the water splitting potential to prevent release of dioxygen, optionally said electrolysis device being supplied with electricity by one or more photovoltaic cells.

14. The electrolysis method according to claim 12, wherein the current density is higher than 10 mA/cm², and for example is higher than 100 mA/cm².

15. The use of coupling a negative water-reducing electrode for the production of dihydrogen with a supercapacitive flow system as positive electrode.
